(19) United States
(12) Patent Application Publication
(10) Pub. No.: US 2026/0330182 A1
(43) Pub. Date: Oct. 22, 2026

(54) GRAPH NEURAL NETWORK TRAINED WITH HETEROGENEOUS GRAPH DATA

(71) Applicant: BYTEDANCE TECHNOLOGY LTD., Grand Cayman (KY)

(72) Inventors: Shichao ZHU, Culver City, CA (US); Guangmou PAN, Culver City, CA (US)

(21) Appl. No.: 19/183,674

(22) Filed: Apr. 18, 2025

(51) Int. Cl. G06N 3/042; G06N 3/08

(52) U.S. Cl. CPC G06N 3/042; G06N 3/08

(57) ABSTRACT

A computing system including one or more processing devices configured to receive heterogeneous graph data including nodes and edges. Subsets of the nodes and edges have different node types and edge types. The processing devices construct a training dataset by sampling source nodes and computing multi-hop paths starting from the source nodes. Multi-hop path edges are sampled with probabilities normalized according to proportions of the edge types in the heterogeneous graph data. Constructing the training dataset further includes selecting positive sample pairs that each include positive sample nodes included in a multi-hop path. Based on the positive sample pairs, the processing devices train a graph neural network (GNN) to compute training-time embeddings of the nodes. The processing devices receive an inferencing input node, and, at the GNN, compute an inferencing-time embedding. The processing devices select and output an inferencing output node based on the inferencing-time embedding.

### BACKGROUND

In social networking platforms, data related to users and their interactions is often represented in graph databases. A graph database stores data in a graph that includes nodes and edges. For example, the nodes of a graph database used in a social networking platform may represent the users of the platform, and the edges may represent interactions between the users. Storing a graph database representation of the users and their interactions may allow some computing processes to be performed more easily and efficiently on the social networking platform data, compared to using other database structures. For example, graph traversal algorithms may be performed to select recommended connections between users.

### SUMMARY

According to one aspect of the present disclosure, a computing system is provided, including one or more processing devices configured to receive heterogeneous graph data including a plurality of nodes and a plurality of edges. A plurality of subsets of the nodes have different corresponding node types and a plurality of subsets of the edges have different corresponding edge types. The one or more processing devices are further configured to construct a training dataset from the heterogeneous graph data at least in part by sampling a plurality of source nodes from among the plurality of nodes. Starting from the source nodes, constructing the training dataset further includes computing a respective plurality of multi-hop paths that each include a corresponding set of multi-hop path nodes and multi-hop path edges. The multi-hop path edges are sampled with respective path edge sampling probabilities normalized according to proportions of the edge types of those multi-hop path edges in the heterogeneous graph data. Constructing the training dataset further includes selecting a plurality of positive sample pairs that each include positive sample nodes included in a multi-hop path of the plurality of multi-hop paths. Based at least in part on the positive sample pairs, the one or more processing devices are further configured to train a graph neural network (GNN) to compute training-time embeddings of the nodes included in the training dataset. The one or more processing devices are further configured to receive an inferencing input node. At the GNN, the one or more processing devices are further configured to compute an inferencing-time embedding based at least in part on the inferencing input node. The one or more processing devices are further configured to select an inferencing output node based at least in part on the inferencing-time embedding. The one or more processing devices are further configured to output the selection of the inferencing output node.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to compute a training dataset from heterogeneous graph data, according to one example embodiment.

FIG. 2 schematically shows an example portion of the heterogeneous graph data, according to the example of FIG. 1.

FIG. 3 schematically shows the computing system during selection of a plurality of source nodes, according to the example of FIG. 1.

FIG. 4 schematically shows the computing system when the one or more processing devices are configured to construct a multi-hop path starting from a source node, according to the example of FIG. 1.

FIG. 5A shows the computing system when the one or more processing devices are configured to compute a first subset of negative sample pairs, according to the example of FIG. 1.

FIG. 5B schematically shows the computing system when the one or more processing devices are configured to compute a second subset of the negative sample pairs, according to the example of FIG. 1.

FIG. 6 schematically shows the computing system during training of a graph neural network (GNN), according to the example of FIG. 1.

FIG. 7A schematically shows the computing system when the GNN is executed at inferencing time in order to identify an inferencing output node via an embedding similarity search, according to the example of FIG. 6.

FIG. 7B schematically shows the computing system when the GNN is executed at inferencing time in order to compute a plurality of clusters of nodes, according to the example of FIG. 6.

FIG. 7C schematically shows the computing system when an inferencing-time embedding computed at the GNN is used as an input to a ranking machine learning (ML) model, according to the example of FIG. 6.

FIG. 8A shows a flowchart of a method for use with a computing system to perform training and inferencing at a GNN, according to the example of FIG. 6.

FIGS. 8B-8D show additional steps of the method of FIG. 8A that may be performed in some examples.

FIG. 9 shows a schematic view of an example computing environment in which the computing system of FIG. 1 may be instantiated.

### DETAILED DESCRIPTION

A graph database associated with a social media platform may be a heterogeneous graph database that includes multiple different data modalities. In an example in which the social media platform is a video uploading platform, the graph database may include nodes that represent videos, video viewers, and video uploaders, along with other potential node types. The graph database may also include edges that represent multiple different types of user behaviors, such as watching a video, commenting on a video, and performing a keyword search, along with other potential edge types.

In social media platform settings, selection of a node that is semantically related to another node is a task frequently performed on graph-structured data. For example, related node identification may be performed when recommending videos, video authors, or products to users. As another example, related node identification may be performed when assigning keywords or genre tags to videos or video authors.

In heterogeneous graph data, some types of nodes and/or edges may be significantly more frequent than others. For example, the number of videos may be much larger than the number of video authors. As another example, liking a video may be much more common than purchasing a product depicted in a video. Accordingly, the differences in frequency between node and edge types are relevant when representing the contents of the social media platform and the behavior of its users during related node selection tasks.

Database scale presents an additional challenge in graph database management. For example, a graph database associated with a social media platform may have a size on the order of billions or tens of billions of nodes, along with tens of billions or hundreds of billions of edges. Such database sizes may make computationally expensive approaches of identifying relationships between different nodes included in the graph data impractical to perform at scale.

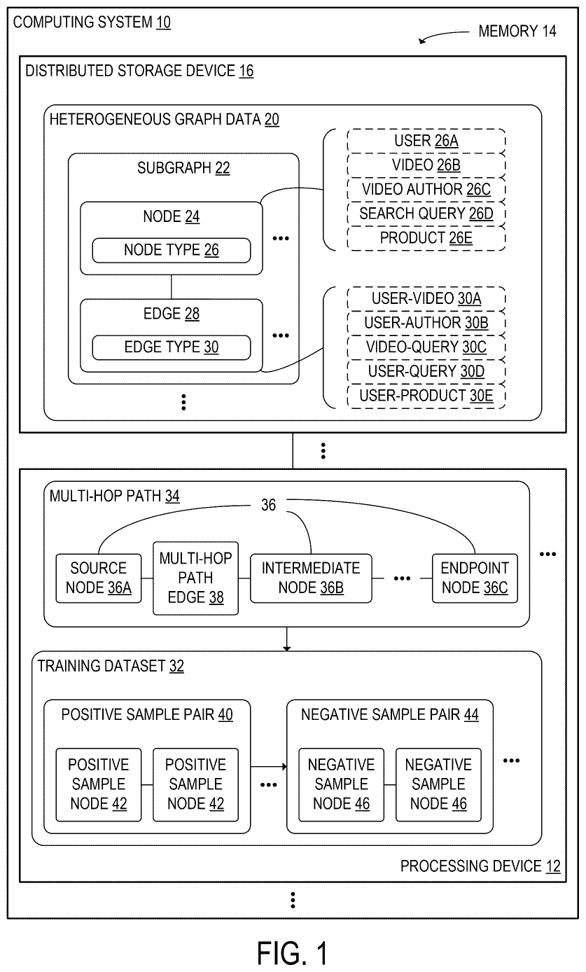

In order to address the challenges discussed above, a computing system 10 is provided, as depicted schematically in the example of FIG. 1. The computing system 10 includes one or more processing devices 12. For example, the one or more processing devices 12 may include one or more central processing units (CPUs), graphics processing units (GPUs), neural processing units (NPUs), and/or other types of processing devices. The computing system 10 further includes memory 14, which may include volatile memory and non-volatile storage. In the example of FIG. 1, the memory 14 includes a plurality of distributed storage devices 16.

The memory 14 stores heterogeneous graph data 20 including a plurality of nodes 24 and a plurality of edges 28. The heterogeneous graph data 20 may, for example, be divided into a plurality of database shards that are stored at respective distributed storage devices 16. A plurality of subsets of the nodes 24 have different corresponding node types 26. In addition, a plurality of subsets of the edges 28 have different corresponding edge types 30.

The heterogeneous graph data 20 may be data received from a social media platform. The node types 26 may indicate types of entities included in the social media platform and may include user 26A, video 26B, video author 26C, search query 26D, and product 26E. Other node types 26 may additionally or alternatively be included in the heterogeneous graph data 20. The edge types 30 may indicate types of interactions between the entities specified by the nodes 24 and may include user-video 30A, user-author 30B, video-query 30C, user-query 30D, and user-product 30E. Other edge types 30 may additionally or alternatively be included in the heterogeneous graph data 20 in other examples. For example, the edge types 30 of the edges 28 may be specified with further detail, as actions such as “like,” “comment,” or “add to cart.”

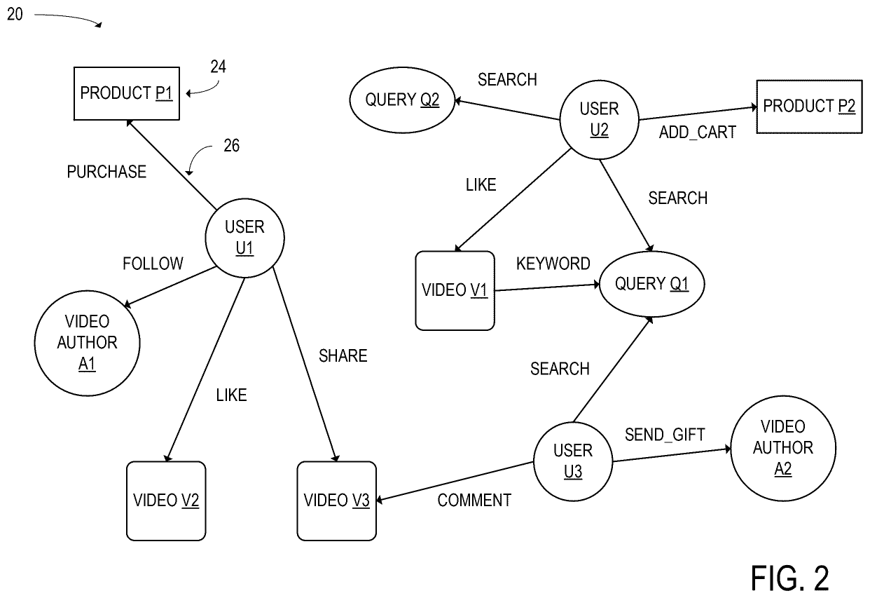

FIG. 2 schematically shows a portion of heterogeneous graph data 20 in an example in which the heterogeneous graph data 20 is received from the social media platform. In the example of FIG. 2, the heterogeneous graph data 20 includes nodes 24 corresponding to users U1, U2, and U3, videos V1, V2, and V3, video authors A1 and A2, queries Q1 and Q2, and products P1 and P2. The nodes 24 are connected by edges 26 with edge types 30 including “purchase” between user U1 and product P1; “follow” between user U1 and video author A1; “like” between user U1 and video V2; “share” between user U1 and video V3; “search” between user U2 and query Q2; “add_cart” between user U2 and product P2; “like” between user U2 and video V1; “search” between user U2 and query Q1; “search” between user U3 and query Q1; “comment” between user U3 and video V3; and “send_gift” between user U3 and video author A2.

Returning to the example of FIG. 1, the heterogeneous graph data 20 is divided into a plurality of subgraphs 22 according to the node types 26 and the edge types 30. Each of the subgraphs 22 includes a plurality of nodes 24 with one or more of the node types 26 included in the heterogeneous graph data 20 and further includes corresponding edges 28 with one or more of the edge types 30 included in the heterogeneous graph data 20. The subgraphs 22 may correspond to different categories of interactions with the social media platform. For example, the heterogeneous graph data 20 may include a live-stream subgraph including node 24 and edges 28 that have corresponding node types 26 and edge types 30 related to user interactions with live streams.

The one or more processing devices 12 are configured to receive the heterogeneous graph data 20 from the memory 14. The heterogeneous graph data 20 received at the one or more processing devices 12 may be a representative sample of a larger graph database stored in the memory 14. For example, such heterogeneous graph data 20 may be the graph data stored at a specific distributed storage device 16 in its corresponding database shard.

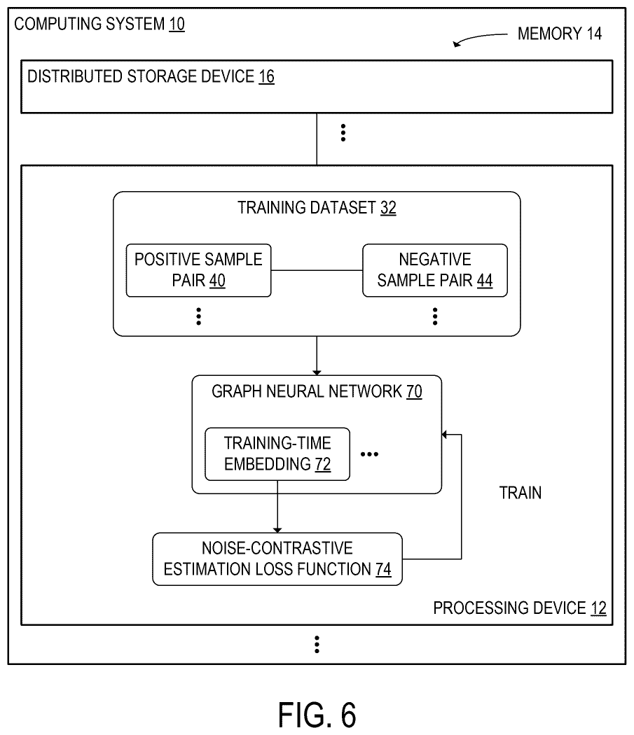

The one or more processing devices 12 are further configured to construct a training dataset 32 from the heterogeneous graph data 20. This training dataset 32 is used to train a graph neural network (GNN) 70, as discussed in further detail below with reference to FIG. 6. The GNN 70 is trained to generate embedding vectors corresponding to nodes 24. When the one or more processing devices 12 construct the training dataset 32, the one or more processing devices 12 are configured to sample the heterogeneous graph data 20 in a manner that accounts for differences in frequency and connectivity patterns between different node types 26 and edge types 30, as discussed below. Such sampling allows the GNN 70 to learn an embedding space that has a high level of detail and distinguishability between different nodes 24.

Constructing the training dataset 32 includes computing a plurality of multi-hop paths 34 through the heterogeneous graph data 20. Each of the multi-hop paths 34 includes a corresponding set of multi-hop path nodes 36 and multi-hop path edges 38. In a multi-hop path 34, the plurality of multi-hop path nodes 36 include a source node 36A, one or more intermediate nodes 36B, and an endpoint node 36C. In some examples, each of the multi-hop paths 34 has a predetermined number of multi-hop path nodes 36 and a predetermined number of multi-hop path edges 38. Computing the multi-hop paths 34 includes sampling a plurality of source nodes 36A from among the plurality of nodes 24. For each of the source nodes 36A, computing the corresponding multi-hop path 34 further includes sampling the subsequent multi-hop path nodes 36 and multi-hop path edges 38 starting from the source node 36A. For example, the one or more processing devices 12 may be configured to sample twelve additional multi-hop path nodes 36 subsequently to each of the source nodes 36A, resulting in multi-hop paths 34 that each include thirteen multi-hop path nodes 36.

The one or more processing devices 12 are further configured to select a plurality of positive sample pairs 40 for inclusion in the training dataset 32. Each of the positive sample pairs 40 includes positive sample nodes 42 included in a multi-hop path 34 of the plurality of multi-hop paths 34. For example, the one or more processing devices 12 may be configured to select the positive sample nodes 42 as a pair of the multi-hop path nodes 36 that are spaced apart from each other by four or fewer multi-hop path edges 38. In such examples, the one or more processing devices 12 are accordingly configured to select positive sample pairs 40 in which the positive sample nodes 42 are located proximate to each other in the heterogeneous graph data 20 without always being immediately adjacent. This range of distances between the positive sample nodes 42 may allow the GNN 70 to develop more detailed representations of user interactions with the social media platform, as discussed in further detail below.

In the example of FIG. 1, the one or more processing devices 12 are further configured to select a plurality of negative sample pairs 44 associated with the positive sample pairs 40. The one or more processing devices 12 may be configured to compute a respective negative sample pair 44 for each of the positive sample pairs 40. The negative sample pairs 44 are pairs of negative sample nodes 46 that are selected, using the techniques discussed in further detail below, to be semantically distant from each other. Thus, using negative sample pairs 44 as well as positive sample pairs 40 when training the GNN 70 may increase differentiation between similar and dissimilar nodes 24.

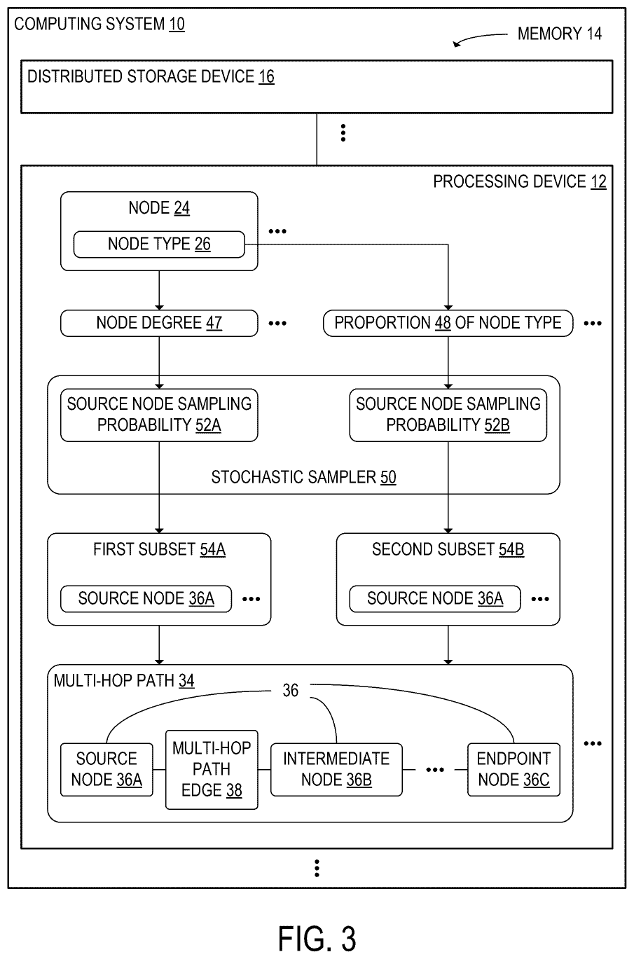

FIG. 3 schematically shows the computing system 10 during selection of the plurality of source nodes 36A. In the example of FIG. 3, the one or more processing devices 12 are configured to sample a first subset 54A and a second subset 54B of the source nodes 36A using different techniques. The one or more processing devices 12 are configured to sample both of the subsets 54A and 54B at a stochastic sampler 50, which may be a pseudorandom number generator. To compute the first subset 54A, the one or more processing devices 12 are configured to sample the source nodes 36A with respective source node sampling probabilities 52A that are scaled based at least in part on respective node degrees 47 of the nodes 24. The node degree 47 of a node 24 is the number of edges 28 connected to that node 24. In some examples, the scaling of the source node sampling probability 52A is proportional to the node degree 47. Thus, the one or more processing devices 12 are configured to sample higher-activity nodes (e.g., a video viewed by a large number of users) with higher source node sampling probabilities 52A.

To compute the second subset 54B, the one or more processing devices 12 are configured to sample the source nodes 36A with respective source node sampling probabilities 52B that are scaled based at least in part on proportions 48 of the node types 26 of those nodes 24 in the heterogeneous graph data 20. In some examples, the source node sampling probabilities 52B of the nodes 24 may be normalized such that the different node types 26 have approximately equal source node sampling probabilities 52B. The plurality of multi-hop paths 34 may accordingly include quantities of less frequently occurring types of source nodes 36A that allow the GNN 70 to learn accurate representations of those node types 26. The one or more processing devices 12 may be configured to compute the proportions 48 of the different node types 26 in the heterogeneous graph data 20 prior to sampling the source nodes 36A.

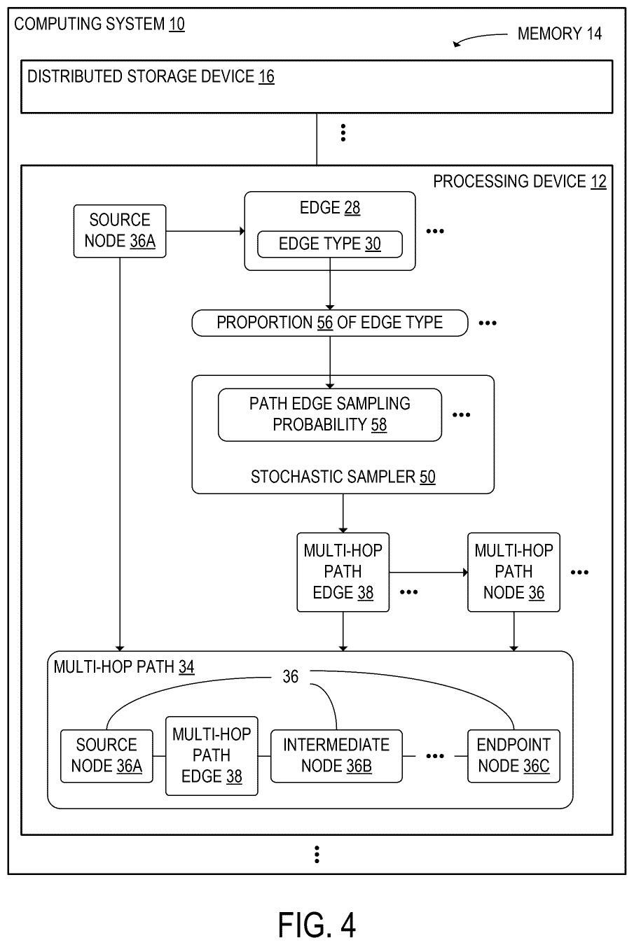

FIG. 4 schematically shows the computing system 10 when the one or more processing devices 12 are configured to construct a multi-hop path 34 starting from a source node 36A. In the example of FIG. 4, the one or more processing devices 12 are configured to select the multi-hop path edges 38 at the stochastic sampler 50 with respective path edge sampling probabilities 58. The path edge sampling probabilities 58 are normalized according to respective proportions 56 of the edge types 30 of those multi-hop path edges 38 in the heterogeneous graph data 20. By normalizing the path edge sampling probabilities 58, the one or more processing devices 12 are configured to construct a set of multi-hop paths 34 that allows the GNN 70 to learn representations of edge types 30 even if those edge types 30 occur infrequently in the heterogeneous graph data 20.

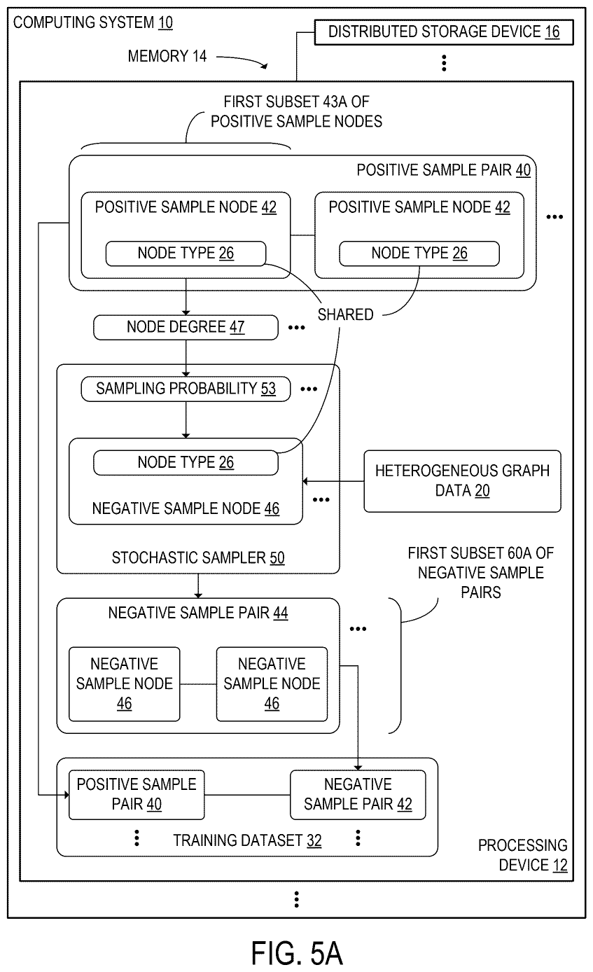

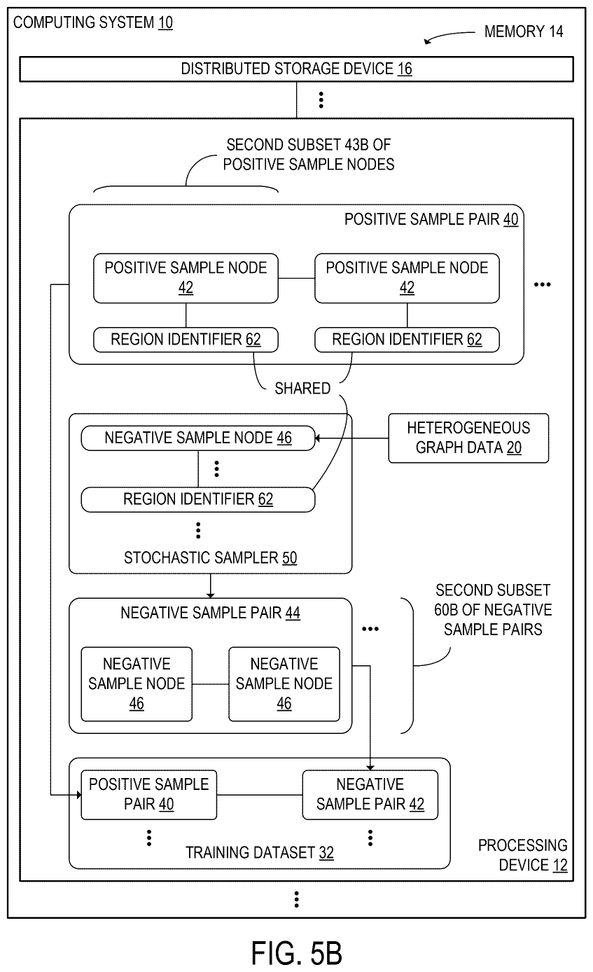

FIGS. 5A-5B schematically show the computing system 10 when the one or more processing devices 12 are configured to compute the plurality of negative sample pairs 44. FIG. 5A shows the computing system 10 when the one or more processing devices 12 are configured to compute a first subset 60A of the negative sample pairs 44 corresponding to a first subset 43A of the positive sample nodes 40. At the stochastic sampler 50, the one or more processing devices 12 are configured to sample, from the heterogeneous graph data 20, a plurality of negative sample nodes 46 that share the node types 26 of the positive sample nodes 42 included in the first subset 43A of the positive sample nodes 42.

By sampling negative sample nodes 46 that have the same node types 26 as the positive sample nodes 42, the one or more processing devices 12 are configured to construct a training dataset 32 that allows the GNN 70 to learn semantic differences between disparate nodes 24 that have the same node types 26. In contrast, negative sample pairs of nodes 24 with different node types 26 may be less informative when training the GNN 70 to have a semantically detailed embedding space.

In the example of FIG. 5A, the one or more processing devices 12 are configured to sample the negative sample nodes 46 included in the first subset 60A of negative sample pairs 44 with respective sampling probabilities 53 that are scaled according to node degrees 47 of those negative sample nodes 46. These sampling probabilities 53 may be proportional to the node degrees 47 of those nodes 24 in the heterogeneous graph data 20, thereby resulting in higher sampling probabilities for higher-activity nodes 24.

FIG. 5B schematically shows the computing system 10 when the one or more processing devices 12 are further configured to compute a second subset 60B of the negative sample pairs 44 corresponding to a second subset 43B of the positive sample nodes 42. In the example of FIG. 5B, the heterogeneous graph data 20 further includes a plurality of region identifiers 62 that indicate languages and/or geographic regions associated with the nodes 24. In some examples, the region identifiers 62 may be included in the node types 26 of the nodes 24, whereas in other examples, the region identifiers 62 may be additional metadata not included in the node types 26. The one or more processing devices 12 are configured to compute the second subset 60B at least in part by sampling, from the heterogeneous graph data 20, a plurality of negative sample nodes 46 that share the region identifiers 62 of the positive sample nodes 42 included in the second subset 43B of the positive sample nodes 42.

By selecting negative sample nodes 46 that share the region identifiers 62 of the positive sample nodes 42, the one or more processing devices 12 may be configured to construct a training dataset 32 that allows the GNN 70 to learn more detailed semantic differences between the positive sample nodes 42 and negative sample nodes 46, rather than learning a less detailed embedding space in which representations of languages and/or geographic regions are tightly clustered. In some examples, when computing the second subset 60B of negative sample pairs 44, the one or more processing devices 12 may also be configured to match the node types 26 of the negative sample nodes 46 to the node types 26 of the corresponding positive sample nodes 42, as in the example of FIG. 5A.

FIG. 6 schematically shows the computing system 10 during training of the GNN 70. The one or more processing devices 12 are configured to train the GNN 70 to compute training-time embeddings 72 of the nodes 24 included in the training dataset 32. In the example of FIG. 6, the one or more processing devices 12 are configured to train the GNN 70 using a noise-contrastive estimation loss function 74. The one or more processing devices 12 may be configured to perform stochastic gradient descent based on values of the noise-contrastive estimation loss function 74 to modify the parameters of the GNN 70.

The noise-contrastive estimation loss function 74 is discussed in further detail below. The one or more processing devices 12 may be configured to train the GNN 70 to approximate the following expression:

$${max}_{v} {\sum }_{{v}_{i} ∈ 𝒱} log Pr ( {N}_{S} ( i ) \vert {v}_{i} )$$

In the above expression, vᵢ is a node, [symbol] is the set of nodes, N_{S}(i)⊂ [symbol] is a multi-hop neighborhood of the node vᵢ generated using a sampling strategy S, and v is the node representation computed at the GNN 70.

In order to make the above maximization problem tractable, the conditional likelihood of a node pair is modeled in this example as a softmax using the dot product of the node representations of the nodes:

$$Pr ( {N}_{S} ( i ) \vert {v}_{i} ) = {\prod }_{{v}_{j} ∈ {N}_{S} ( i )} Pr ( {v}_{j} \vert {v}_{i} ) \\ Pr ( {v}_{j} \vert {v}_{i} ) = \frac{exp ( {v}_{j} \cdot {v}_{i} )}{{\sum }_{{v}_{n} ∈ 𝒱} exp ( {v}_{n} \cdot {v}_{i} )}$$

In the above equations, vⱼ denotes the multi-hop neighbor node of the source node vᵢ. vₙ denotes the negative sample node of the source node vᵢ.

The noise-contrastive estimation loss function 74 is computed as follows in this example:

$$ℒ ( {v}_{i} , {v}_{j} ) = - log \frac{exp ( {v}_{i} \cdot {v}_{j} )}{exp ( {v}_{i} \cdot {v}_{j} ) + {\sum }_{n ∈ 𝒩} exp ( {v}_{i} \cdot {v}_{n} )}$$

In the above equation, (vᵢ, vⱼ) denotes a positive sample pair and (vᵢ, vₙ) denotes a negative sample pair. [symbol] is the set of negative sample nodes with the same node type as vⱼ. The above loss function trains the GNN 70 to compute similar training-time embeddings 72 for the positive sample nodes 42 but dissimilar training-time embeddings 72 for the negative sample nodes 46.

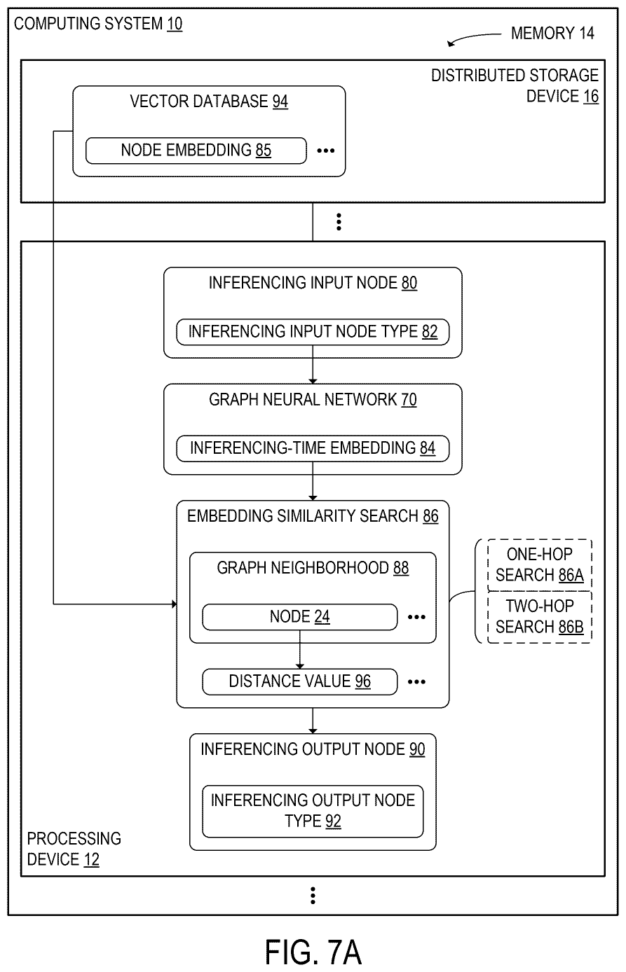

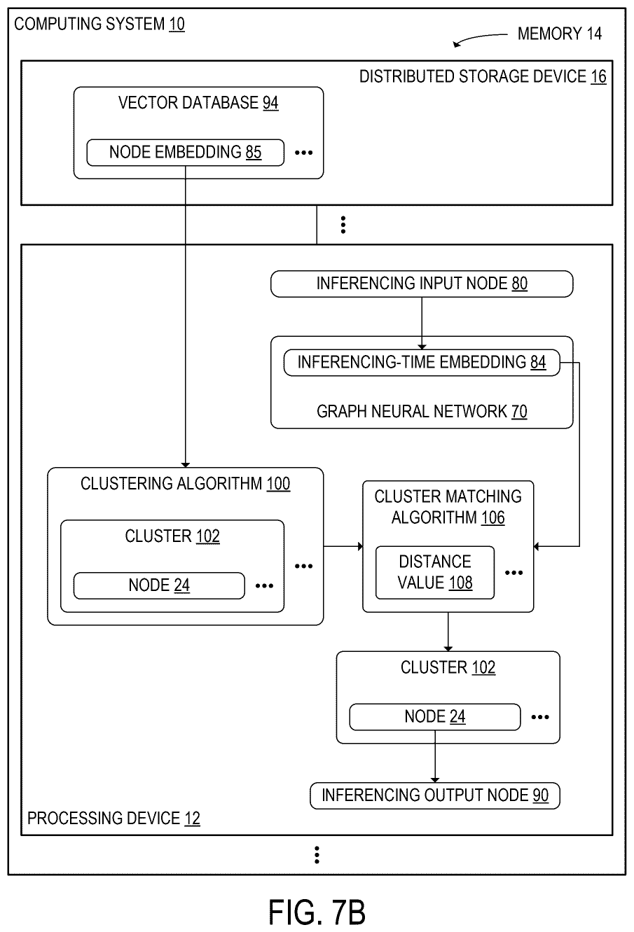

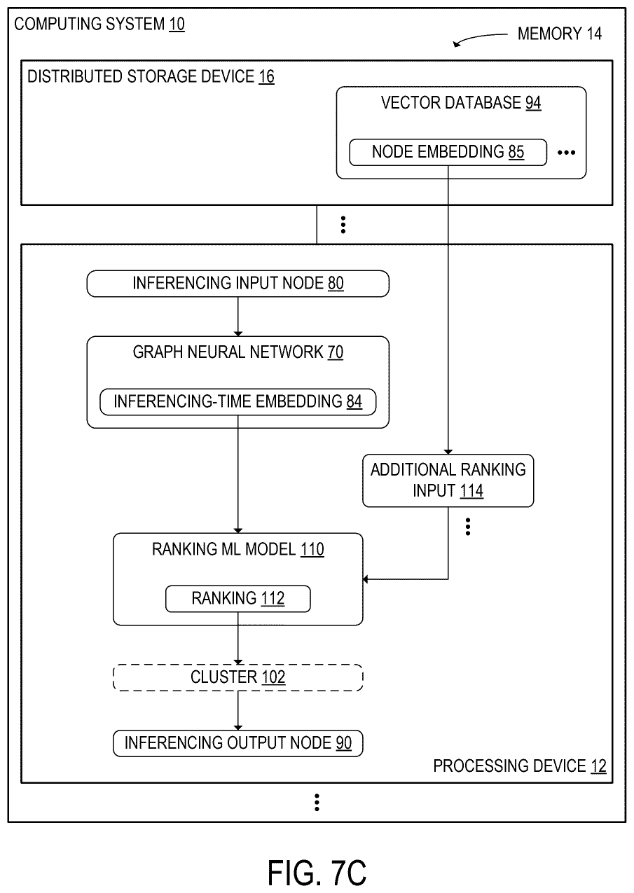

FIGS. 7A-7C schematically show the computing system 10 when the one or more processing devices 12 are configured to execute the GNN 70 at inference time. As shown in the example of FIG. 7A, the one or more processing devices 12 are configured to receive an inferencing input node 80. The inferencing input node 80 has an inferencing input node type 82. In some examples, the inferencing input node 80 is included in the heterogeneous graph data 20. In other examples, the inferencing input node 80 is not included in the heterogeneous graph data 20 that is used to train the GNN 70. For example, the one or more processing devices 12 may be configured to update the GNN 70 at some predetermined time interval, and the inferencing input node 80 may be a node received subsequently to the most recent update, such as a video uploaded to the social media platform after the training dataset 32 is computed.

At the GNN 70, the one or more processing devices 12 are further configured to compute an inferencing-time embedding 84 based at least in part on the inferencing input node 80. The inferencing-time embedding 84 is a vector representation of the inferencing input node 80 in the embedding space of the GNN 70.

The one or more processing devices 12 are further configured to select an inferencing output node 90 based at least in part on the inferencing-time embedding 84. The inferencing output node 90 has an inferencing output node type 92. The one or more processing devices 12 are further configured to output the selection of the inferencing output node 90. For example, the one or more processing devices 12 may be configured to present the inferencing output node 90 as a video recommendation or a search result that is presented to the user via a user interface.

FIGS. 7A-7C show respective examples of techniques by which the inferencing-time embedding 84 may be used to select the inferencing output node 90. In the example of FIG. 7A, the one or more processing devices 12 are configured to select the inferencing output node at least in part by performing an embedding similarity search 86 over at least a portion of the plurality of nodes 24 included in the heterogeneous graph data 20. In some examples, such as those in which additional nodes 24 and/or edges 28 are stored in the memory 14 subsequently to the construction of the training dataset 32, the embedding similarity search 86 may also be performed over one or more nodes 24 not included in the heterogeneous graph data 20. The embedding similarity search 86 may be a search over nodes 24 included in a graph neighborhood 88 of the inferencing input node 80, which includes the nodes 24 within a predetermined number of edges 28 of the inferencing input node 80. For example, the embedding similarity search 86 may be a one-hop search 86A or a two-hop search 86B starting from the inferencing input node 80.

When the one or more processing devices 12 perform the embedding similarity search 86, the one or more processing devices 12 may be configured to compute respective node embeddings 85 of each of the nodes 24 over which the embedding similarity search 86 is performed. In some examples, the memory 14 may store one or more of these node embeddings 85 in a vector database 94 so as to avoid having to recompute the node embeddings 85. The one or more processing devices 12 may be further configured to compute respective distance values 96 (e.g., L2 distances) between the inferencing-time embedding 84 and each of the node embeddings 85. The one or more processing devices 12 may be further configured to select, as the inferencing output node 90, a node 24 with a lowest distance value 96 from the inferencing input node 80. As another example, the inferencing output node 90 may be sampled with a sampling probability that decreases with increasing distance. Thus, the one or more processing devices 12 may be configured to use the node embeddings 85 to quantify the similarity of different nodes 24.

FIG. 7B shows an example in which the one or more processing devices 12 are further configured to compute a plurality of clusters 102 of at least a portion of the plurality of nodes 24. These clusters 102 are computed based at least in part on respective node embeddings 85 computed for those nodes 24 at the GNN 70. In the example of FIG. 7B, the one or more processing devices 12 are configured to execute a clustering algorithm 100 over a plurality of pre-computed node embeddings 85 stored in a vector database 94, as in the example of FIG. 7A. The clustering algorithm 100 may, for example, be k-means clustering or an approximation thereof.

In the example of FIG. 7B, the one or more processing devices 12 are further configured to select the inferencing output node 90 at least in part by matching the inferencing-time embedding 84 to a cluster 102 of the plurality of clusters 102. For example, the one or more processing devices 12 may be configured to execute a cluster matching algorithm 106 at which the one or more processing devices 12 compute respective distance values 108 between the inferencing time embedding 84 and respective mean embedding values of each of the clusters 102. The one or more processing devices 12 may be further configured to select the cluster 102 with the lowest distance value 108. The one or more processing devices 12 may be further configured to select the inferencing output node 90 from among the nodes 24 included in the selected cluster 102. For example, the one or more processing devices 12 may be further configured to perform an embedding similarity search 86 over the cluster 102 using the techniques discussed above with reference to FIG. 7A.

FIG. 7C schematically shows the computing system 10 in an example in which the one or more processing devices 12 are further configured to input the inferencing-time embedding 84 into a ranking machine learning (ML) model 110. At the ranking ML model 110, the one or more processing devices 12 may be configured to compute a ranking 112 over at least a portion of the plurality of nodes 24 based at least in part on the inferencing-time embedding 84. The one or more processing devices 12 may be further configured to select the inferencing output node 90 based at least in part on the ranking 112. For example, the ranking ML model 110 may be a classifier model configured to compute the ranking 112 as a set of logits over potential inferencing output nodes 90. As another example, the ranking 112 may be a ranking over a plurality of different clusters 102 to which the one or more processing devices 12 may be configured to match the inferencing input node 80.

In some examples, the ranking ML model 110 may receive one or more additional inputs 114 when used to compute the ranking 112. For example, the ranking ML model 110 may receive a plurality of node embeddings 85 from a vector database 94. In such examples, the ranking ML model 110 may be configured to compute the ranking 112 as a ranking over the nodes 24 for which the node embeddings 85 are received. The ranking ML model 110 may accordingly be used in place of a distance function in an embedding similarity search 86.

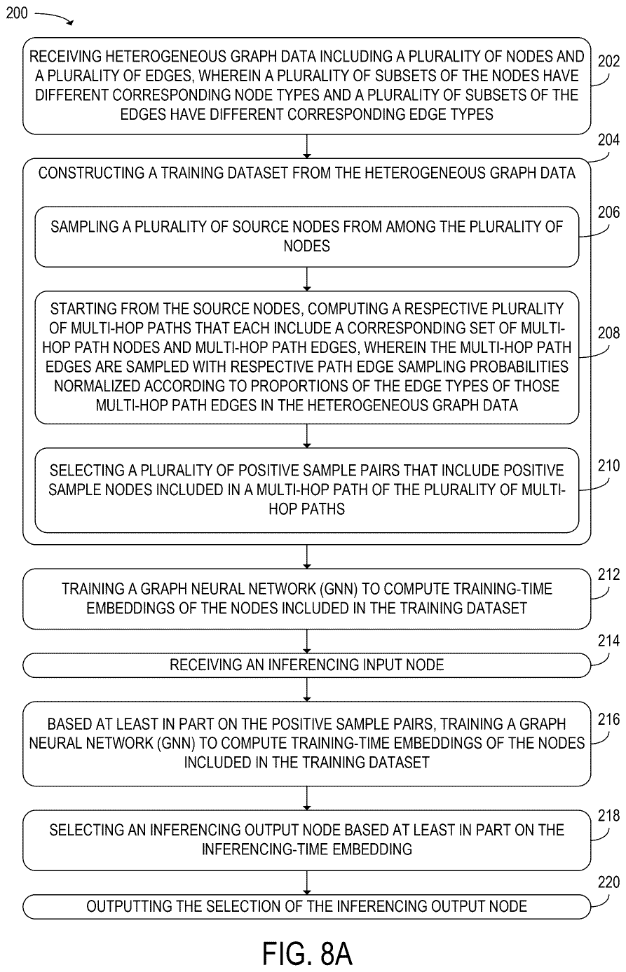

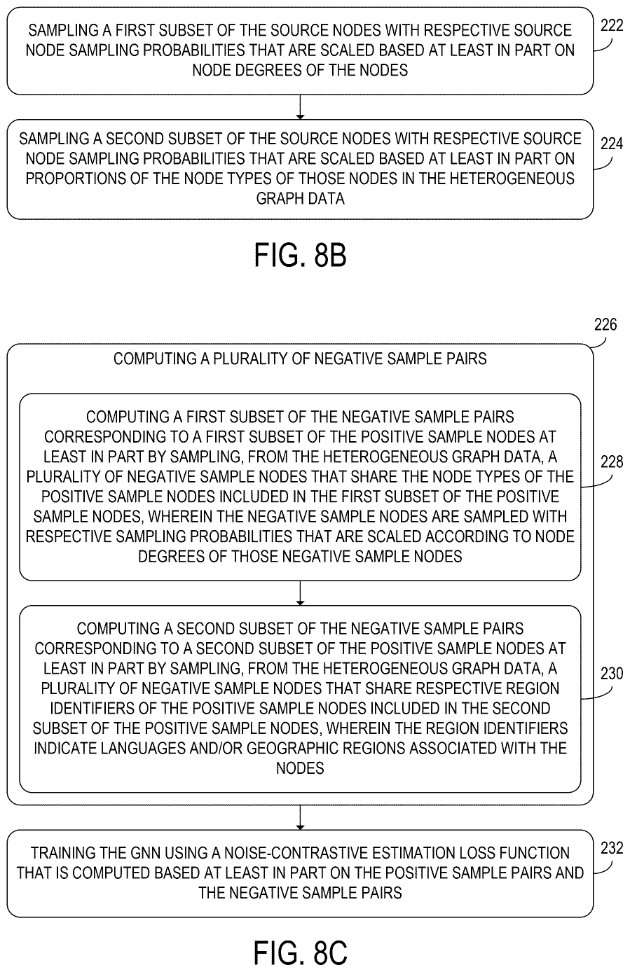

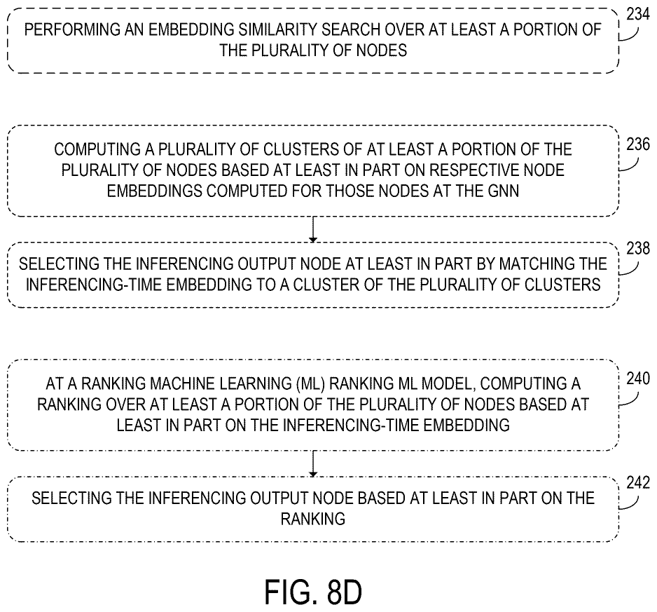

FIG. 8A shows a flowchart of a method 200 for use with a computing system to perform training and inferencing at a GNN. At step 202, the method 200 includes receiving heterogeneous graph data including a plurality of nodes and a plurality of edges. A plurality of subsets of the nodes have different corresponding node types and a plurality of subsets of the edges have different corresponding edge types. For example, the heterogeneous graph data may be received from a social media platform. In this example, the node types may indicate types of entities included in the social media platform and may include user, video, video author, search query, and product. The edge types may indicate types of interactions between the entities specified by the nodes and may include user-video, user-author, video-query, user-query, and user-product.

At step 204, the method 200 further includes constructing a training dataset from the heterogeneous graph data. Constructing the training dataset at step 204 includes, at step 206, sampling a plurality of source nodes from among the plurality of nodes.

At step 208, constructing the training dataset at step 204 further includes computing a respective plurality of multi-hop paths starting from the source nodes. The multi-hop paths each include a corresponding set of multi-hop path nodes and multi-hop path edges. The multi-hop path edges are sampled with respective path edge sampling probabilities normalized according to proportions of the edge types of those multi-hop path edges in the heterogeneous graph data. Thus, infrequently occurring edge types are represented in the set of multi-hop paths. Each of the multi-hop paths may have a predetermined multi-hop path length in some examples.

At step 210, constructing the training dataset at step 204 further includes selecting a plurality of positive sample pairs. The positive sample pairs each include positive sample nodes included in a multi-hop path of the plurality of multi-hop paths. In some examples, in order to obtain positive sample pairs of nodes that are semantically related to each other, step 210 may include selecting pairs of multi-hop path nodes within a predetermined number of edges from each other, where that predetermined number of edges is shorter than the multi-hop path length.

At step 212, the method 200 further includes training a GNN based at least in part on the positive sample pairs included in the training dataset. The GNN is trained to compute training-time embeddings of the nodes included in the training dataset. The training dataset computed at step 204 is constructed in a manner that allows the GNN to learn semantically detailed representations of the nodes at step 212.

At step 214, subsequently to training the GNN, the method 200 further includes receiving an inferencing input node. The inferencing input node may be a node included in the heterogeneous data or may be received from outside the heterogeneous graph data. At step 216, the method 200 further includes computing an inferencing-time embedding at the GNN based at least in part on the inferencing input node.

At step 218, the method 200 further includes selecting an inferencing output node based at least in part on the inferencing-time embedding. At step 220, the method 200 further includes outputting the selection of the inferencing output node. For example, the selection of the inferencing output node may be a recommendation (e.g., of a video or a video author) that is presented to a user at a user interface.

FIGS. 8B-8D show additional steps of the method 200 that may be performed in some examples. FIG. 8B shows additional steps that may be performed when selecting the source nodes at step 206. At step 222, sampling the plurality of source nodes at step 206 may include sampling a first subset of the source nodes with respective source node sampling probabilities that are scaled based at least in part on node degrees of the nodes. The source node sampling probabilities may be scaled such that nodes with higher node degrees are more likely to be sampled as source nodes.

At step 224, sampling the plurality of source nodes at step 206 may include sampling a second subset of the source nodes with respective source node sampling probabilities that are scaled based at least in part on proportions of the node types of those nodes in the heterogeneous graph data. For example, the source node sampling probabilities of the nodes may be normalized according to the proportions of the node types in the heterogeneous graph data. Alternatively, some other weighting may be used to compute the source node sampling probabilities.

FIG. 8C shows additional steps of the method 200 that may be performed in examples in which the training dataset further includes a plurality of negative sample pairs of nodes. At step 226, the method 200 further includes computing the plurality of negative sample pairs. In some examples, a corresponding negative sample pair is computed for each positive sample pair. The negative sample pairs may be pairs of semantically distant nodes included in the heterogeneous graph data.

At step 228, computing the negative sample pairs at step 226 may include computing a first subset of the negative sample pairs corresponding to a first subset of the positive sample nodes. The first subset of negative sample nodes may be computed at least in part by sampling, from the heterogeneous graph data, a plurality of negative sample nodes that share the node types of the positive sample nodes included in the first subset of the positive sample nodes. These negative sample nodes may be sampled with respective sampling probabilities that are scaled according to node degrees of those negative sample nodes. Thus, nodes that are connected to higher numbers of edges are more likely to be sampled as negative sample nodes.

At step 230, computing the negative sample pairs at step 226 may further include computing a second subset of the negative sample pairs corresponding to a second subset of the positive sample nodes. The second subset may be computed at least in part by sampling, from the heterogeneous graph data, a plurality of negative sample nodes that share respective region identifiers of the positive sample nodes included in the second subset of the positive sample nodes. The region identifiers may indicate languages and/or geographic regions associated with the nodes. In some examples, the region identifiers may be included in the node types. By selecting negative sample pairs that share the region identifiers of the positive sample nodes, the negative sample pairs may be selected in a manner that allows the GNN to learn semantic features of the nodes that are more detailed than differences in language or dialect.

At step 232, training the GNN at step 216 may include training the GNN using a noise-contrastive estimation loss function that is computed based at least in part on the positive sample pairs and a corresponding plurality of negative sample pairs. Accordingly, the GNN may learn to distinguish between related and unrelated pairs of nodes.

FIG. 8D shows example steps that may be performed when selecting the inferencing output node at step 218. In some examples, at step 234, step 218 may include performing an embedding similarity search over at least a portion of the plurality of nodes. One or more other nodes, such as one or more nodes received subsequently to the construction of the training dataset, may also be included in the embedding similarity search in some examples. The embedding similarity search may include computing distance values between the inferencing-time embedding and respective node embeddings of the nodes included in the search domain. The node with the shortest distance to the inferencing input node may be selected as the inferencing output node. Alternatively, the inferencing output node may be stochastically sampled with a sampling probability that decreases with increasing distance from the inferencing-time embedding.

In some examples, at step 236, step 218 may include computing a plurality of clusters of at least a portion of the plurality of nodes. The clusters may be computed based at least in part on respective node embeddings computed for the nodes at the GNN. For example, step 236 may include performing k-means clustering over the node embeddings.

At step 238, step 218 may further include selecting the inferencing output node at least in part by matching the inferencing-time embedding to a cluster of the plurality of clusters. For example, subsequently to matching the inferencing-time embedding to the cluster, the inferencing output node may be selected by performing an embedding similarity search within that cluster.

In some examples, at step 240, step 218 may include computing a ranking at a ranking ML model. The ranking ML model may compute the ranking over at least a portion of the plurality of nodes based at least in part on the inferencing-time embedding. At step 242, step 218 may further include selecting the inferencing output node based at least in part on the ranking. For example, the ranking ML model may also receive a plurality of node embeddings and may be used in place of a distance function when performing an embedding similarity search.

Using the systems and methods discussed above, a GNN is trained to extract embeddings from nodes included in heterogeneous graph data. The GNN is trained using a training dataset constructed in a manner that allows the GNN to learn a semantically detailed embedding space over the different types of nodes included in the heterogeneous graph data, even when some types of nodes occur much less frequently than others. The GNN is used to compute inferencing-time embeddings of inferencing input nodes, which may, for example, be used to identify related nodes in the heterogeneous graph data. For example, the inferencing output nodes may be recommendations generated at a social media platform. The systems and methods discussed above may allow for efficient identification of related nodes in large volumes of heterogeneous graph data.

The methods and processes described herein are tied to a computing system of one or more computing devices. In particular, such methods and processes can be implemented as a computer-application program or service, an application-programming interface (API), a library, and/or other computer-program product.

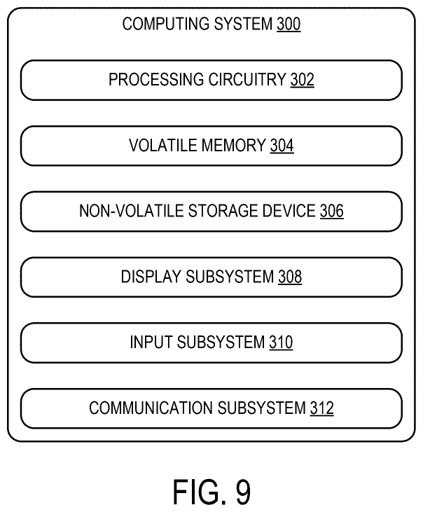

FIG. 9 schematically shows a non-limiting embodiment of a computing system 300 that can enact one or more of the methods and processes described above. Computing system 300 is shown in simplified form and may instantiate the computing system 10 depicted in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 9.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed, e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory 304, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive heterogeneous graph data including a plurality of nodes and a plurality of edges. A plurality of subsets of the nodes have different corresponding node types and a plurality of subsets of the edges have different corresponding edge types. The one or more processing devices are further configured to construct a training dataset from the heterogeneous graph data at least in part by sampling a plurality of source nodes from among the plurality of nodes. Constructing the training dataset further includes, starting from the source nodes, computing a respective plurality of multi-hop paths that each include a corresponding set of multi-hop path nodes and multi-hop path edges. The multi-hop path edges are sampled with respective path edge sampling probabilities normalized according to proportions of the edge types of those multi-hop path edges in the heterogeneous graph data. Constructing the training dataset further includes selecting a plurality of positive sample pairs that each include positive sample nodes included in a multi-hop path of the plurality of multi-hop paths. Based at least in part on the positive sample pairs, the one or more processing devices are further configured to train a graph neural network (GNN) to compute training-time embeddings of the nodes included in the training dataset. The one or more processing devices are further configured to receive an inferencing input node. At the GNN, the one or more processing devices are further configured to compute an inferencing-time embedding based at least in part on the inferencing input node. The one or more processing devices are further configured to select an inferencing output node based at least in part on the inferencing-time embedding. The one or more processing devices are further configured to output the selection of the inferencing output node. The above features may have the technical effect of computing and utilizing embeddings over heterogeneous graph data in which different node types and edge types occur with different frequencies.

According to this aspect, the one or more processing devices may be configured to sample a first subset of the source nodes with respective source node sampling probabilities that are scaled based at least in part on node degrees of the nodes. The above features may have the technical effect of sampling higher-activity nodes with higher source node sampling probabilities.

According to this aspect, the one or more processing devices may be configured to sample a second subset of the source nodes with respective source node sampling probabilities that are scaled based at least in part on proportions of the node types of those nodes in the heterogeneous graph data. The above features may have the technical effect of increasing the representation of low-frequency nodes in the training dataset by increasing the probability of sampling those low-frequency nodes as the source nodes.

According to this aspect, the one or more processing devices may be configured to train the GNN using a noise-contrastive estimation loss function. The noise-contrastive estimation loss function may be computed based at least in part on the positive sample pairs and a corresponding plurality of negative sample pairs. The above features may have the technical effect of training the GNN to distinguish between the positive sample pairs and the negative sample pairs.

According to this aspect, the one or more processing devices may be configured to compute a first subset of the negative sample pairs corresponding to a first subset of the positive sample nodes at least in part by sampling, from the heterogeneous graph data, a plurality of negative sample nodes that share the node types of the positive sample nodes included in the first subset of the positive sample nodes. The above features may have the technical effect of training the GNN to distinguish between semantically dissimilar nodes that share the same node type.

According to this aspect, the one or more processing devices may be configured to sample the negative sample nodes with respective sampling probabilities that are scaled according to node degrees of those negative sample nodes. The above features may have the technical effect of sampling higher-activity nodes with higher sampling probabilities.

According to this aspect, the heterogeneous graph data may further include a plurality of region identifiers that indicate languages and/or geographic regions associated with the nodes. The one or more processing devices may be configured to compute a second subset of the negative sample pairs corresponding to a second subset of the positive sample nodes at least in part by sampling, from the heterogeneous graph data, a plurality of negative sample nodes that share the region identifiers of the positive sample nodes included in the second subset of the positive sample nodes. The above features may have the technical effect of training the GNN to distinguish between semantically dissimilar nodes that share the same language or originate from the same geographic region.

According to this aspect, the one or more processing devices may be configured to select the inferencing output node at least in part by performing an embedding similarity search over at least a portion of the plurality of nodes. The above features may have the technical effect of using the inferencing-time embedding to identify an inferencing output node that is semantically similar to the inferencing input node.

According to this aspect, the embedding similarity search may be a one-hop search or a two-hop search starting from the inferencing input node. The above features may have the technical effect of identifying a semantically related inferencing output node.

According to this aspect, the one or more processing devices may be further configured to compute a plurality of clusters of at least a portion of the plurality of nodes based at least in part on respective node embeddings computed for those nodes at the GNN. The one or more processing devices may be further configured to select the inferencing output node at least in part by matching the inferencing-time embedding to a cluster of the plurality of clusters. The above features may have the technical effect of using the inferencing-time embedding to identify a genre, topic, or keyword associated with the inferencing input node.

According to this aspect, at a ranking machine learning (ML) ranking ML model, the one or more processing devices may be further configured to compute a ranking over at least a portion of the plurality of nodes based at least in part on the inferencing-time embedding. The one or more processing devices may be further configured to select the inferencing output node based at least in part on the ranking. The above features may have the technical effect of ranking the nodes according to a semantic property indicated in the inferencing-time embedding.

According to this aspect, the heterogeneous graph data may be received from a social media platform. The node types may indicate types of entities included in the social media platform and include user, video, video author, search query, and product. The edge types may indicate types of interactions between the entities specified by the nodes and include user-video, user-author, video-query, user-query, and user-product. The above features may have the technical effect of training the GNN to model user interactions with the social media platform.

According to another aspect of the present disclosure, a method for use with a computing system is provided. The method includes receiving heterogeneous graph data including a plurality of nodes and a plurality of edges. A plurality of subsets of the nodes have different corresponding node types and a plurality of subsets of the edges have different corresponding edge types. The method further includes constructing a training dataset from the heterogeneous graph data at least in part by sampling a plurality of source nodes from among the plurality of nodes. Constructing the training dataset further includes, starting from the source nodes, computing a respective plurality of multi-hop paths that each include a corresponding set of multi-hop path nodes and multi-hop path edges. The multi-hop path edges are sampled with respective path edge sampling probabilities normalized according to proportions of the edge types of those multi-hop path edges in the heterogeneous graph data. Constructing the training dataset further includes selecting a plurality of positive sample pairs that each include positive sample nodes included in a multi-hop path of the plurality of multi-hop paths. Based at least in part on the positive sample pairs, the method further includes training a graph neural network (GNN) to compute training-time embeddings of the nodes included in the training dataset. The method further includes receiving an inferencing input node. At the GNN, the method further includes computing an inferencing-time embedding based at least in part on the inferencing input node. The method further includes selecting an inferencing output node based at least in part on the inferencing-time embedding. The method further includes outputting the selection of the inferencing output node. The above features may have the technical effect of computing and utilizing embeddings over heterogeneous graph data in which different node types and edge types occur with different frequencies.

According to this aspect, sampling the plurality of source nodes may include sampling a first subset of the source nodes with respective source node sampling probabilities that are scaled based at least in part on node degrees of the nodes. The above features may have the technical effect of sampling higher-activity nodes with higher source node sampling probabilities.

According to this aspect, sampling the plurality of source nodes may include sampling a second subset of the source nodes with respective source node sampling probabilities that are scaled based at least in part on proportions of the node types of those nodes in the heterogeneous graph data. The above features may have the technical effect of increasing the representation of low-frequency nodes in the training dataset by increasing the probability of sampling those low-frequency nodes as the source nodes.

According to this aspect, the GNN may be trained using a noise-contrastive estimation loss function. The noise-contrastive estimation loss function may be computed based at least in part on the positive sample pairs and a corresponding plurality of negative sample pairs. The above features may have the technical effect of training the GNN to distinguish between the positive sample pairs and the negative sample pairs.

According to this aspect, the method may further include computing a first subset of the negative sample pairs corresponding to a first subset of the positive sample nodes at least in part by sampling, from the heterogeneous graph data, a plurality of negative sample nodes that share the node types of the positive sample nodes included in the first subset of the positive sample nodes. The negative sample nodes may be sampled with respective sampling probabilities that are scaled according to node degrees of those negative sample nodes. The above features may have the technical effect of training the GNN to distinguish between semantically dissimilar nodes that share the same node type.

According to this aspect, the method may further include computing a second subset of the negative sample pairs corresponding to a second subset of the positive sample nodes at least in part by sampling, from the heterogeneous graph data, a plurality of negative sample nodes that share respective region identifiers of the positive sample nodes included in the second subset of the positive sample nodes. The region identifiers may indicate languages and/or geographic regions associated with the nodes. The above features may have the technical effect of training the GNN to distinguish between semantically dissimilar nodes that share the same language or originate from the same geographic region.

According to this aspect, the method may further include selecting the inferencing output node at least in part by performing an embedding similarity search over at least a portion of the plurality of nodes. The above features may have the technical effect of using the inferencing-time embedding to identify an inferencing output node that is semantically similar to the inferencing input node.

According to another aspect of the present disclosure, a computing system is provided, including one or more processing devices configured to receive heterogeneous graph data including a plurality of nodes and a plurality of edges. A plurality of subsets of the nodes have different corresponding node types and a plurality of subsets of the edges have different corresponding edge types. The one or more processing devices are further configured to construct a training dataset from the heterogeneous graph data at least in part by sampling a plurality of source nodes from among the plurality of nodes. Constructing the training dataset further includes, starting from the source nodes, computing a respective plurality of multi-hop paths that each include a corresponding set of multi-hop path nodes and multi-hop path edges. The multi-hop path edges are sampled with respective path edge sampling probabilities that are computed based at least in part on proportions of the edge types of those multi-hop path edges in the heterogeneous graph data. Constructing the training dataset further includes selecting a plurality of positive sample pairs that each include positive sample nodes included in a multi-hop path of the plurality of multi-hop paths. Constructing the training dataset further includes selecting a plurality of negative sample pairs that each include negative sample nodes. Based at least in part on the positive sample pairs and the negative sample pairs, the one or more processing devices are further configured to train a graph neural network (GNN) to compute training-time embeddings of the nodes included in the training dataset. The one or more processing devices are further configured to receive an inferencing input node. At the GNN, the one or more processing devices are further configured to compute an inferencing-time embedding based at least in part on the inferencing input node. The one or more processing devices are further configured to select an inferencing output node based at least in part on the inferencing-time embedding. The one or more processing devices are further configured to output the selection of the inferencing output node. The above features may have the technical effect of computing and utilizing embeddings over heterogeneous graph data in which different node types and edge types occur with different frequencies.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive heterogeneous graph data including a plurality of nodes and a plurality of edges, wherein a plurality of subsets of the nodes have different corresponding node types and a plurality of subsets of the edges have different corresponding edge types;
construct a training dataset from the heterogeneous graph data at least in part by:
sampling a plurality of source nodes from among the plurality of nodes;
starting from the source nodes, computing a respective plurality of multi-hop paths that each include a corresponding set of multi-hop path nodes and multi-hop path edges, wherein the multi-hop path edges are sampled with respective path edge sampling probabilities normalized according to proportions of the edge types of those multi-hop path edges in the heterogeneous graph data; and
selecting a plurality of positive sample pairs that each include positive sample nodes included in a multi-hop path of the plurality of multi-hop paths;
based at least in part on the positive sample pairs, train a graph neural network (GNN) to compute training-time embeddings of the nodes included in the training dataset;
receive an inferencing input node;
at the GNN, compute an inferencing-time embedding based at least in part on the inferencing input node;
select an inferencing output node based at least in part on the inferencing-time embedding; and
output the selection of the inferencing output node.

2. The computing system of claim 1, wherein the one or more processing devices are configured to sample a first subset of the source nodes with respective source node sampling probabilities that are scaled based at least in part on node degrees of the nodes.

3. The computing system of claim 1, wherein the one or more processing devices are configured to sample a second subset of the source nodes with respective source node sampling probabilities that are scaled based at least in part on proportions of the node types of those nodes in the heterogeneous graph data.

4. The computing system of claim 1, wherein:
the one or more processing devices are configured to train the GNN using a noise-contrastive estimation loss function;
the noise-contrastive estimation loss function is computed based at least in part on the positive sample pairs and a corresponding plurality of negative sample pairs.

5. The computing system of claim 4, wherein the one or more processing devices are configured to compute a first subset of the negative sample pairs corresponding to a first subset of the positive sample nodes at least in part by sampling, from the heterogeneous graph data, a plurality of negative sample nodes that share the node types of the positive sample nodes included in the first subset of the positive sample nodes.

6. The computing system of claim 5, wherein the one or more processing devices are configured to sample the negative sample nodes with respective sampling probabilities that are scaled according to node degrees of those negative sample nodes.

7. The computing system of claim 4, wherein:
the heterogeneous graph data further includes a plurality of region identifiers that indicate languages and/or geographic regions associated with the nodes; and
the one or more processing devices are configured to compute a second subset of the negative sample pairs corresponding to a second subset of the positive sample nodes at least in part by sampling, from the heterogeneous graph data, a plurality of negative sample nodes that share the region identifiers of the positive sample nodes included in the second subset of the positive sample nodes.

8. The computing system of claim 1, wherein the one or more processing devices are configured to select the inferencing output node at least in part by performing an embedding similarity search over at least a portion of the plurality of nodes.

9. The computing system of claim 8, wherein the embedding similarity search is a one-hop search or a two-hop search starting from the inferencing input node.

10. The computing system of claim 1, wherein the one or more processing devices are further configured to:
compute a plurality of clusters of at least a portion of the plurality of nodes based at least in part on respective node embeddings computed for those nodes at the GNN; and
select the inferencing output node at least in part by matching the inferencing-time embedding to a cluster of the plurality of clusters.

11. The computing system of claim 1, wherein the one or more processing devices are further configured to:
at a ranking machine learning (ML) ranking ML model, compute a ranking over at least a portion of the plurality of nodes based at least in part on the inferencing-time embedding; and
select the inferencing output node based at least in part on the ranking.

12. The computing system of claim 1, wherein:
the heterogeneous graph data is received from a social media platform;
the node types indicate types of entities included in the social media platform and include user, video, video author, search query, and product; and
the edge types indicate types of interactions between the entities specified by the nodes and include user-video, user-author, video-query, user-query, and user-product.

13. A method for use with a computing system, the method comprising:
receiving heterogeneous graph data including a plurality of nodes and a plurality of edges, wherein a plurality of subsets of the nodes have different corresponding node types and a plurality of subsets of the edges have different corresponding edge types;
constructing a training dataset from the heterogeneous graph data at least in part by:
sampling a plurality of source nodes from among the plurality of nodes;
starting from the source nodes, computing a respective plurality of multi-hop paths that each include a corresponding set of multi-hop path nodes and multi-hop path edges, wherein the multi-hop path edges are sampled with respective path edge sampling probabilities normalized according to proportions of the edge types of those multi-hop path edges in the heterogeneous graph data; and
selecting a plurality of positive sample pairs that each include positive sample nodes included in a multi-hop path of the plurality of multi-hop paths;
based at least in part on the positive sample pairs, training a graph neural network (GNN) to compute training-time embeddings of the nodes included in the training dataset;
receiving an inferencing input node;
at the GNN, computing an inferencing-time embedding based at least in part on the inferencing input node;
selecting an inferencing output node based at least in part on the inferencing-time embedding; and
outputting the selection of the inferencing output node.

14. The method of claim 13, wherein sampling the plurality of source nodes includes sampling a first subset of the source nodes with respective source node sampling probabilities that are scaled based at least in part on node degrees of the nodes.

15. The method of claim 13, wherein sampling the plurality of source nodes includes sampling a second subset of the source nodes with respective source node sampling probabilities that are scaled based at least in part on proportions of the node types of those nodes in the heterogeneous graph data.

16. The method of claim 13, wherein:
the GNN is trained using a noise-contrastive estimation loss function; and
the noise-contrastive estimation loss function is computed based at least in part on the positive sample pairs and a corresponding plurality of negative sample pairs.

17. The method of claim 16, further comprising computing a first subset of the negative sample pairs corresponding to a first subset of the positive sample nodes at least in part by sampling, from the heterogeneous graph data, a plurality of negative sample nodes that share the node types of the positive sample nodes included in the first subset of the positive sample nodes,
wherein the negative sample nodes are sampled with respective sampling probabilities that are scaled according to node degrees of those negative sample nodes.

18. The method of claim 16, further comprising computing a second subset of the negative sample pairs corresponding to a second subset of the positive sample nodes at least in part by sampling, from the heterogeneous graph data, a plurality of negative sample nodes that share respective region identifiers of the positive sample nodes included in the second subset of the positive sample nodes,
wherein the region identifiers indicate languages and/or geographic regions associated with the nodes.

19. The method of claim 13, further comprising selecting the inferencing output node at least in part by performing an embedding similarity search over at least a portion of the plurality of nodes.

20. A computing system comprising:
one or more processing devices configured to:
receive heterogeneous graph data including a plurality of nodes and a plurality of edges, wherein a plurality of subsets of the nodes have different corresponding node types and a plurality of subsets of the edges have different corresponding edge types;
construct a training dataset from the heterogeneous graph data at least in part by:
sampling a plurality of source nodes from among the plurality of nodes;
starting from the source nodes, computing a respective plurality of multi-hop paths that each include a corresponding set of multi-hop path nodes and multi-hop path edges, wherein the multi-hop path edges are sampled with respective path edge sampling probabilities that are computed based at least in part on proportions of the edge types of those multi-hop path edges in the heterogeneous graph data; and
selecting a plurality of positive sample pairs that each include positive sample nodes included in a multi-hop path of the plurality of multi-hop paths;
selecting a plurality of negative sample pairs that each include negative sample nodes;
based at least in part on the positive sample pairs and the negative sample pairs, train a graph neural network (GNN) to compute training-time embeddings of the nodes included in the training dataset;
receive an inferencing input node;
at the GNN, compute an inferencing-time embedding based at least in part on the inferencing input node;
select an inferencing output node based at least in part on the inferencing-time embedding; and
output the selection of the inferencing output node.
